(19) United States
(12) Patent Application Publication
(10) Pub. No.: US 2007/0251235 A1
(43) Pub. Date: Nov. 1, 2007

(54) Internal combustion engine comprising an exhaust gas recirculation device

(76) Inventors: Wolfram Schmid, Nuertigen (DE); Siegfried Sumser, Stuttgart (DE)

Correspondence Address: KLAUS J. BACH, 4407 TWIN OAKS DRIVE, MURRYSVILLE, PA, 15668, US

(21) Appl. No.: 11/784,204

(22) Filed: Apr. 5, 2007

Related U.S. Application Data
(63) Continuation-in-part of application No. PCT/EP05/10616, filed on Oct. 1, 2005.

(30) Foreign Application Priority Data
Oct. 8, 2004 (DE) 10 2004 049 218.2

(51) Int. Cl. F02B 33/44; F02D 23/00; F02B 25/06; F02B 47/08; F02M 25/07

(52) U.S. Cl. 60/605.2; 60/602; 123/572; 123/585; 123/568.12

(57) ABSTRACT

In an internal combustion engine with an intake tract and an exhaust tract, an exhaust gas recirculation device with a recirculation line between the exhaust tract and the intake tract and a controllable recirculation valve arranged in the recirculation line, the intact tract includes, upstream of the connection of the recirculation line to the intake tract, an air separation device, via which the combustion air stream in the intake tract can be separated into an oxygen-rich partial air stream and a oxygen-depleted partial air stream for delivery to the cylinders of the internal combustion engine during part load engine operation in order to increase engine operating efficiency and reduce engine emissions.

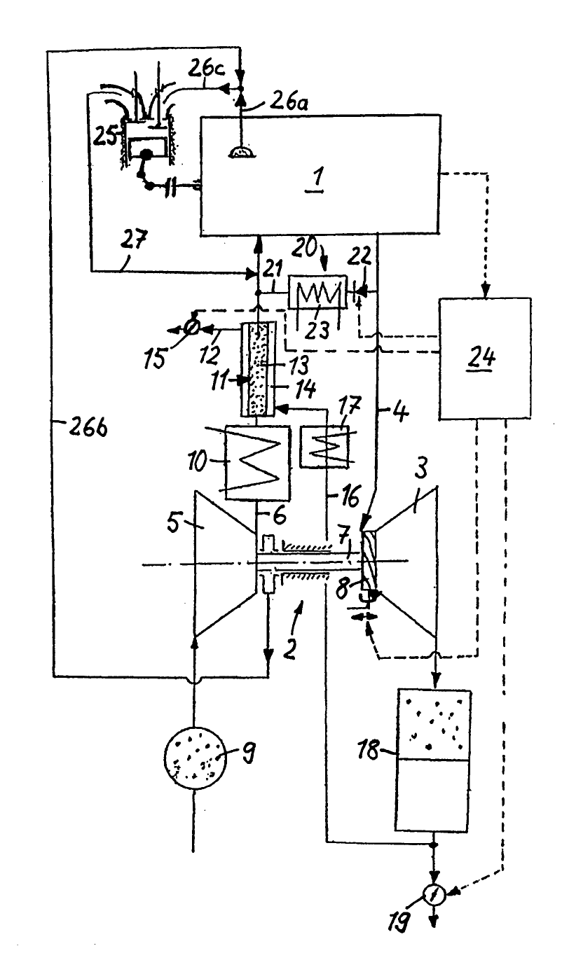

This is a Continuation-in-Part Application of pending International Patent Application PCT/EP2005/010616 filed Oct. 1, 2005 and claiming the priority of German Patent Application 10 2004 049 218.2 filed Oct. 8, 2004.

### BACKGROUND OF THE INVENTION

The invention relates to an internal combustion engine with exhaust gas recirculation including a recirculation line extending between the exhaust tract and the intake tract and having a controllable shutoff valve disposed in the recirculation line.

DE 199 43 132 A1 discloses an internal combustion engine comprising an exhaust gas turbocharger, and an air separation device for reducing the NOₓ emissions, disposed in the intake tract of the internal combustion engine. A selectively permeable diaphragm device of the air separation device divides the combustion air into a low-oxygen and an oxygen-enriched air stream. The air separation device however forms a flow resistance which has to be compensated for by increased compressor work.

DE 102 45 388 A1 describes an internal combustion engine with an exhaust gas turbocharger, including an exhaust gas turbine arranged in the exhaust tract and a compressor coupled fixedly in terms of rotation to the exhaust gas turbine arranged in the intake tract. The exhaust gas turbine is driven by the exhaust gases from the internal combustion engine, and the rotation thereof is transmitted via a shaft to the compressor which thereupon sucks in combustion air which is under ambient pressure and compresses it to an increased boost pressure. To reduce the NOₓ emissions, the internal combustion engine is equipped with an exhaust gas recirculation device which comprises a recirculation line between the exhaust tract upstream of the exhaust gas turbine and the intake tract downstream of the compressor, including a shut-off valve in the recirculation line. Particularly in the part load range, the shut-off valve in the exhaust gas recirculation line is opened, whereupon a part mass flow of the exhaust gas which is under pressure is returned from the exhaust tract via the recirculation line to the intake tract and is mixed there with the combustion air supplied. With exhaust gas recirculation, however, there is the problem that the components coming into contact with the exhaust gas are subject to contamination and, at high temperatures, possibly to carbonization. For example, a heat exchanger arranged in the exhaust gas recirculation line is exposed to the risk of contamination or carbonization. This is accompanied by malfunctions or operating deficiencies.

In order to reduce the oxygen fraction in the combustion air and, along with this, also the NOₓ emissions during part load operation, it is proposed, according to an alternative version described in the publication DE 102 33 182 A1, to provide in the intake tract, instead of exhaust gas recirculation, an air separation device which is capable of separating the combustion air supplied into a first part stream with reduced oxygen and a second part stream with an increased oxygen fraction. The part stream with a reduced oxygen content or with an increased nitrogen fraction is delivered as combustion air to the cylinders of the internal combustion engine, whereas the part air stream with an increased oxygen fraction is discharged into the surrounding air. The mass flow with reduced oxygen content which participates in combustion is to lead to a reduction in nitrogen oxide emission.

The air separation device constitutes a flow resistance which has to be compensated by increased compressor work. This is to be taken into account in dimensioning the exhaust gas turbocharger.

It is the object of the present invention to reduce the nitrogen oxide emissions of an internal combustion engine while ensuring that the efficiency of the internal combustion engine is impaired as little as possible.

### SUMMARY OF THE INVENTION

In an internal combustion engine with an intake tract and an exhaust tract, an exhaust gas recirculation device with a recirculation line between the exhaust tract and the intake tract and a controllable recirculation valve arranged in the recirculation line, the intact tract includes, upstream of the connection of the recirculation line to the intake tract, an air separation device, via which the combustion air stream in the intake tract can be separated into an oxygen-rich partial air stream and a oxygen-depleted partial air stream for delivery to the cylinders of the internal combustion engine during part load engine operation in order to increase engine operating efficiency and reduce engine emissions.

The internal combustion engine according to the invention has both an exhaust gas recirculation device and an air separation device in the intake tract, so that the advantages of the two systems are combined. It is possible in this way to reduce in certain operating phases the oxygen fraction in the combustion air delivered to the cylinders of the engine. The part stream with reduced oxygen content, or with a relatively increased nitrogen fraction, is delivered to the cylinders of the internal combustion engine, with the result that a reduction in nitrogen oxide emission, particularly when the internal combustion engine is operating under part load, can be achieved. The second part air stream with enriched oxygen is expediently discharged into the atmosphere, even a further use of this part air stream may be considered, where appropriate.

Q Since, in the type of operation with shut-off exhaust gas recirculation, the oxygen reduction in the combustion air stream or the nitrogen enrichment takes place solely via the air separation device and any admixing of exhaust gas is prevented, also no other components of the internal combustion engine can become contaminated or carbonized. The service life of these components is thereby increased considerably.

To improve efficiency, it may be expedient to open the exhaust gas recirculation, so that exhaust gas is transferred out of the exhaust tract into the intake tract. Because of the increased exhaust gas backpressure, this can be carried out within a relatively broad operating characteristic map. In this case, expediently, the combustion air is additionally separated in the air separation device into the two part streams, the part stream with reduced oxygen content being intermixed with the recirculated exhaust gas. Since the exhaust gas is introduced into the intake tract downstream of the air separation device, a contamination of the air separation device is reliably ruled out. On account of the intermixing of combustion air with a reduced oxygen content and exhaust gas, a lower exhaust gas mass flow can participate in recirculation than is the case in versions of the prior art. As a result of this, too, the degree of contamination or of carbonization is reduced.

Moreover, via the separate control of the air separation device and of the exhaust gas recirculation device, there is an additional degree of freedom which makes it possible to provide a ratio of recirculated exhaust gas to oxygen-reduced combustion air such that an optimized type of operation can be achieved in a wide operating range. Thus, for example, also the combustion air flow conducted through the air separation device may be reduced and the recirculated exhaust gas mass flow may be correspondingly increased, up to the point where no air separation is carried out, so that the combustion air is delivered, without air separation, to the cylinders of the internal combustion engine in a known way with or without exhaust gas recirculation, depending on the operating point.

The air separation device may be supplied with a scavenging gas which is conducted into a scavenging space in the housing of the air separation device, the part air stream with an enriched oxygen content being introduced into said scavenging space. The air separation device normally has a semi-permeable diaphragm at which air separation takes place by means of an osmotic pressure difference. The scavenging gas, which is introduced into the scavenging space and is discharged from the scavenging space again via a discharge port or discharge line, has a lower oxygen concentration than the atmospheric air, so that different concentrations are present at opposite sides of the diaphragm and osmosis through the diaphragm becomes possible.

The scavenging gas used may be exhaust gas which is expediently picked up downstream of a purification device in the exhaust tract and which is delivered to the scavenging space via a scavenging gas line. In order to provide for a flow of the purified exhaust gas into the scavenging space, it may be expedient to provide in the exhaust tract, downstream of the branch-off of the scavenging gas line, a controllable shut-off valve which can be adjusted into a closed position or partly closed position in order to increase the exhaust gas backpressure promoting recirculation.

A controllable shut-off valve may also be arranged in the region of the outlet of the scavenging space, or in the region of an outlet line which branches off from the scavenging space, and, in the shut-off state, prevents discharge from the scavenging space, whereupon air separation by means of diffusion practically no longer takes place and the overall combustion air stream introduced into the intake tract passes through the air separation device and is led into the cylinders of the internal combustion engine. This corresponds to putting the air separation device out of operation.

Furthermore, it is advantageous to provide an exhaust gas turbocharger with an exhaust gas turbine in the exhaust tract and with a compressor in the intake tract. The exhaust gas turbine may be equipped with variable turbine geometry for the variable setting of the effective turbine inlet cross section, this being implementable for example by means of a guide vane structure arranged in the flow inlet cross section and having adjustable guide vanes or by means of a guide vane structure capable of being pushed axially into the flow inlet cross section. The variable turbine geometry affords an additional control possibility, whereby the exhaust gas backpressure can be increased upstream of the exhaust gas turbine in a flow restricting position minimizing the flow inlet cross-section and the exhaust gas backpressure can be reduced if the guide vane structure is open maximizing the flow inlet cross section.

Finally, it may be expedient to provide to the internal combustion engine with a blow-by pump which sucks vent gases away from the internal combustion engine or from an assembly assigned to the internal combustion engine and feeds them into the exhaust tract downstream of the air separation device. These vent gases are in particular the gases from the crankcase of the internal combustion engine, although vent gases enriched with oil droplets from the housing of the exhaust gas turbocharger may also be considered. Since these vent gases are conducted into the intake tract downstream of the air separation device, contamination of the air separation device is reliably prevented.

The invention will become more readily apparent from the following description thereof on the basis of the accompanying drawing.

### BRIEF DESCRIPTION OF THE DRAWING

The sole FIGURE is a diagrammatic illustration of a supercharged internal combustion engine with exhaust gas recirculation and with an air separation device.

### DESCRIPTION OF A PARTICULAR EMBODIMENT

The internal combustion engine 1, a diesel internal combustion engine or a gasoline engine, is equipped with an exhaust gas turbocharger 2 which comprises an exhaust gas turbine 3 in the exhaust tract 4 and a compressor 5 in the intake tract 6, the turbine wheel being coupled fixedly in the terms of rotation to the compressor wheel via a shaft 7. The turbine wheel of the exhaust gas turbine 3 is driven by the exhaust gases of the internal combustion engine 1 which are under excess pressure, this rotational movement being transmitted via the shaft 7 to the compressor wheel of the compressor 5 which thereupon sucks in combustion air from the surroundings and compresses it to an increased boost pressure.

The compressor 5 is preceded in the intake tract 6 by an air filter 9. Downstream of the compressor 5, a charge air cooler 10, which cools the compressed combustion air, is located in the intake tract 6. Further downstream of the charge air cooler 10, in the intake tract, an air separation device 11 is located, which separates the combustion air stream into two part air streams, to be precise a part air stream which is enriched with oxygen and which can be discharged into the atmosphere via an outlet line 12 and an oxygen-reduced part air stream which is led further on into the intake tract 6 and finally is delivered to the cylinders of the internal combustion engine 1. Located in the housing of the air separation device 11 is a semi-permeable diaphragm 13 or a plurality of such diaphragms, at which gas separation into the part air streams with reduced oxygen content and with an enriched oxygen content takes place. The part air stream with an enriched oxygen content is conducted into a scavenging space 14 which surrounds the diaphragms 13 and from which the outlet line 12 branches off. A controllable shut-off valve 15 is located in the outlet line 12.

A scavenging gas line 16 which branches off from the exhaust tract 4 downstream of an exhaust gas purification device 18 is connected to the scavenging space 14 of the air separation device 11. The exhaust gas purification device 18 comprises a soot filter and a catalyst, for example a Denox catalyst. Exhaust gas is delivered as scavenging gas to the air separation device 11 via the scavenging gas line 16 in which a heat exchanger 17 for cooling the scavenging gas is located. With the shut-off valve 15 open, the exhaust gas is discharged as scavenging gas, together with the diffused-out part air stream with an increased oxygen content, from the scavenging space 14.

Downstream of the branch-off of the scavenging gas line 16 from the exhaust tract 4, a further controllable shut-off valve 19 is arranged in the exhaust tract. When the shut-off valve 19 is closed, the pressure in the exhaust tract upstream of the shut-off valve 19 rises thereby increasing the recirculation flow of exhaust gas as scavenging gas into the air separation device 11.

The compressor 3 is provided with a variable turbine geometry 8, via which the effective turbine inlet cross section can be adjusted between a minimum flow or blocking position and a maximum opening position. This may be utilized in various operating phases of the internal combustion engine in order to increase power. A power increase can be achieved both in fired driving type of operation and in unfired engine braking operation.

Moreover, to assist exhaust gas recirculation from the exhaust tract into the intake tract, the variable turbine geometry 8 can be adjusted in the direction of the blocking position, in order to control the pressure drop between the exhaust tract 4 and intake tract 6. Exhaust gas recirculation is carried out by means of an exhaust gas recirculation device 20 comprising a recirculation line 21 which branches off from the exhaust tract 4 upstream of the exhaust gas turbine 3 and extends to the intake tract 6 downstream of the air separation device 11. A controllable shut-off valve 22 and an exhaust gas cooler 23 are located in the recirculation line 21.

All the assemblies of the internal combustion engine 1 can be set as a function of state and operating variables of the internal combustion engine 1 via a regulating and control unit 24. This refers particularly to the variable turbine geometry 8, the shut-off valve 15 and the outlet line 12 of the air separation device 11, the shut-off valve 19 downstream of the exhaust gas purification device 18 in the exhaust tract 4 and the shut-off valve 22 in the exhaust gas recirculation device 20.

Moreover, the internal combustion engine 1 is provided with a blow-by gas pump 25 which is expediently driven directly by the internal combustion engine 1, but, if appropriate, may also be operated independently of the engine. Via the blow-by pump 25, vent gases from the internal combustion engine and/or from an assembly of the internal combustion engine are sucked away and introduced into the intake tract downstream of the separation device 11 and of the point of issue of the exhaust gas recirculation line 21 into the intake tract 6, so that the vent gases are delivered to the combustion process. A venting of the crankcase of the internal combustion engine 1, as indicated via a vent line 26a, is provided. Furthermore, the oil loss of the exhaust gas turbocharger 2 can also be sucked away, for which purpose a vent line 26b branches off from the housing of the supercharger. The vent lines 26a and 26b extend to a common line portion 26c, via which the vent gases are delivered to the blow-by gas pump 25. A further vent line 27 extends from the blow-by gas pump and to the intake tract 6 downstream of the air separation device 11 and of the exhaust gas recirculation device 20, so that the unpurified vent gases are delivered only directly upstream of the cylinder inlet of the internal combustion engine. Contamination, in particular, of the air separation device 11 is thereby prevented.

When the internal combustion engine is in operation, the air separation capacity of the air separation device 11 can be controlled via the position of the shut-off valves 15 and 19 in the outlet line 12 and in the exhaust tract 4. With the shut-off valve 15 in the outlet line 12 closed, practically no air separation takes place. With the shut-off valve 15 open and, if appropriate, with a shut-off or partly shut-off valve 19 in the exhaust tract 4 for the transfer of exhaust gas as scavenging gas into the scavenging space 14 of the air separation device 11, the latter exercises its action and separates the combustion air stream supplied into the two part streams with a reduced and with an enriched oxygen content. The part air stream with reduced oxygen content, that is, with an increased nitrogen fraction is delivered to the cylinders of the internal combustion engine 1, with the result that a reduction in nitrogen oxide emissions can be achieved particularly when the internal combustion engine is operating under part load. Via a setting of the shut-off valve 22 in the exhaust gas purification device 18, part of the exhaust gas can be branched off from the exhaust tract and returned to the intake tract and intermixed therein with the part mass flow of combustion air with an increased nitrogen fraction. If appropriate, however, a complete shut-off of the shut-off valve 22 may also be considered, so that no exhaust gas is recirculated. The shut-off, already mentioned, of the shut-off valve 15 in the outlet line 12 of the air separation device 11 may likewise be considered, with the result that air separation is practically ruled out and the overall combustion air stream is conducted through the air separation device 11 and delivered to the internal combustion engine 1.

What is claimed is:

1. An internal combustion engine including an exhaust tract (4) and an intake tract (6), an exhaust gas recirculation device with a recirculation line (21) extending between the exhaust tract (4) and the intake tract (6) and a controllable shut-off valve (22) arranged in the recirculation line (21), an air separation device (11) arranged, in the intake tract (6) upstream of the connection of the recirculation line (21) to the intake tract (6), via which the combustion air stream in the intake tract (6) is separated into an oxygen-enriched partial air stream and an oxygen-depleted partial air stream for delivery to the cylinders of the internal combustion engine (1), and a scavenging gas line (16) branching off from the exhaust tract (4) downstream of a purification device (18) in the exhaust tract (4) and extending to the air separation device (11) for supplying exhaust gas as scavenging gas to the air separation device (11), a controllable shut-off valve (19) arranged in the exhaust tract (4) downstream of the branch-off of the scavenging gas line (16) from the exhaust tract (4), and an outlet line (12) extending from the air separation device (11) for the discharge of the scavenging gas from the air separation device (11) and including a controllable shut-off valve (15), and an exhaust gas turbocharger (2) with an exhaust gas turbine (3) arranged in the exhaust tract (4) and with a compressor (5) arranged in the intake tract (6), the exhaust gas turbine (3) including variable turbine geometry (8) for controlling the effective turbine inlet cross-section and a blow-by gas pump (25) for sucking vent gases out of the internal combustion engine (1) and feeding them into the exhaust tract (4) downstream of the air separation device (11).

2. The internal combustion engine as claimed in claim 1, wherein the blow-by gas pump is connected to the engine interior for removing the vent gases originating from the crankcase of the internal combustion engine (1).

3. The internal combustion engine as claimed in claim 1, wherein the blow-by pump is connected to the exhaust gas turbocharger for removing vent gases originating from the housing of the exhaust gas turbocharger (2).

4. The internal combustion engine as claimed in claim 1, wherein to prevent a contamination of the air separation device (11), a vent line (27) extends from the blow-by gas pump (25) and joins the intake tract (6) downstream of the air separation device (11) and of the exhaust gas recirculation device (20).

5. The internal combustion engine as claimed in claim 1, wherein the exhaust gas recirculation line (21) includes a shut-off valve (22) for controlling the amount of exhaust gas supplied to the low-oxygen partial air stream.
